(19) United States
(12) Patent Application Publication
(10) Pub. No.: US 2009/0038447 A1
(43) Pub. Date: Feb. 12, 2009

(54) SCREW GUIDE AND METHOD OF OPERATION THEREOF

(75) Inventors: Robert E. McCracken, Anderson, SC (US); Thomas M. Parel, Anderson, SC (US); Lilia F. Macias, Anderson, SC (US); Thomas D. Evatt, Six Mile, SC (US); Ryan T. Harrison, Anderson, SC (US); Taku Ohi, Greer, SC (US)

Correspondence Address: MICHAEL, BEST & FRIEDRICH LLP, 100 EAST WISCONSIN AVENUE, SUITE 3300, MILWAUKEE, WI, 53202, US

(73) Assignee: Eastway Fair Company Limited, Tortola (VG)

(21) Appl. No.: 12/184,562

(22) Filed: Aug. 1, 2008

Related U.S. Application Data
(60) Provisional application No. 60/964,123, filed on Aug. 9, 2007.

(51) Int. Cl. B25B 23/10

(52) U.S. Cl. 81/454

(57) ABSTRACT

A screw guide and a method of driving a screw into a work surface utilizing a driving tool and a screw guide. The screw guide having a body configured to be coupled with a rotating clamp of the rotary tool, the body defining a chamber for receiving a screw, and a support member coupled with the body and configured to maintain the screw in an orientation substantially parallel with the axis of the rotating clamp.

### CROSS-REFERENCE TO RELATED APPLICATION

This patent application claims the benefit under 35 U.S.C. § 119(e) of U.S. provisional patent application Serial No. 60/964,123, filed Aug. 9, 2007 and entitled SCREW GUIDE, the entire contents of which is incorporated herein by reference.

### BACKGROUND OF THE INVENTION

1. Field of the Invention

The present invention relates to a screw guide for supporting a screw while the screw is being driven into a work surface and a method of operation thereof. More specifically, the present invention relates to a screw guide having a cylinder for receiving the screw and at least one support member supporting the screw in a desired orientation.

2. Related Technology

Screw guides are used to support a screw while it is driven into a work surface to maintain the screw in a desired orientation and cause the screw to be driven into the work surface at the desired angle, such as perpendicular to the work surface. More specifically, screw guides are coupled with a rotary tool, such as an electric drill, to provide support for the screw during drilling and to maintain the position of the screw in a desired orientation. However, currently-known screw guides include an undesirably large gap between the screw guide support surface(s) and the screw, thereby permitting the screw to become skewed with respect to the axis of the drill driving tool and potentially causing the screw to be driven into the work surface at an undesired angle. Therefore, such currently-known screw guides may be unable to maintain the screw in a desired orientation.

### BRIEF SUMMARY OF THE INVENTION

In one aspect, the present invention includes a screw guide for a rotary tool having a rotating clamp rotatable about an axis. The screw guide includes a body rotatably coupled with the rotating clamp of the rotary tool and defining a chamber for receiving a screw. The screw guide also includes a support member coupled with the body for maintaining the screw in an orientation substantially parallel with the axis.

In another aspect, the support member includes a plurality of support members. The plurality of support members may be a plurality of flexible members configured to maintain the screw in an orientation substantially completely parallel with the axis. The flexible members may be each positioned around the axis such as to cooperate to urge the screw in the orientation substantially completely parallel with the axis. For example, the screw guide may include three flexible members, such as spring arms, generally evenly spaced from each other around a circumference of the body.

In yet another aspect, the plurality of support members are each configured to move between an open position for loading the screw within the chamber, where the support members are each a first distance from the axis, and a closed position for supporting the screw, where the support members are each a second distance from the axis that is less than the first distance.

In another aspect, the present invention may include an adjustment ring coupled with the body to adjust the position of the support members with respect to the axis. The adjustment ring may include a plurality of cam surfaces each configured to selectively engage one of the support members to adjust the position thereof with respect to the axis.

In yet another aspect, the body includes an outer portion defining a plurality of proximal openings extending into the chamber and each of the plurality of support members is a spring member including a base portion fixably coupled with the outer portion of the body and a head portion configured to extend into one of the plurality of proximal openings and engage the screw. The spring members may be biased towards a closed position and the screw guide may include an o-ring positioned around the plurality of spring members to urge the spring members towards the closed position

In another aspect, the body includes an inner portion telescopically received within an outer portion, and the inner portion is configured to move between a protracted position and a retracted position. When the inner portion is in the protracted position, it engages plurality of spring members and urges them into the open position.

In yet another aspect, the present invention includes a method of driving a screw into a work surface utilizing a driving tool and a screw guide having support members. The method includes positioning the support members of the screw guide into an open position, loading the screw into engagement with a driving component of the screw guide, and positioning the support members of the screw guide such that the support members secure the screw in an orientation substantially parallel with an axis of the driving component.

Further objects, features and advantages of the invention will become readily apparent to persons skilled in the art after a review of the following description, with reference to the drawings and claims that are appended to and form a part of this specification.

### BRIEF DESCRIPTION OF THE DRAWINGS

FIG. 1 is a side view of an exemplary rotary tool rotatably coupled with a screw guide embodying principles of the present invention;

FIG. 2a is an isometric view of the screw guide shown in FIG. 1, where the screw guide body is in the retracted position for loading a screw onto the screw guide;

FIG. 2b is an isometric view of the screw guide shown in FIG. 1, where the screw guide body is in the protracted position for supporting the screw in a desired orientation;

FIG. 3a is a cross-sectional view taken along line 3-3 in FIG. 1, where the screw guide body is in the protracted position and the support members are in an open position;

FIG. 3b is a cross-sectional view taken along line 3-3 in FIG. 1, where the screw guide body is in the retracted position and the support members are in a closed position;

FIG. 4 is a cross-sectional view of another screw guide embodying principles of the present invention, where the screw guide includes an adjustment ring for adjusting the position of the support members; and

FIG. 5 is a top view of the adjustment ring for use with the screw guide shown in FIG. 4.

### DETAILED DESCRIPTION OF THE INVENTION

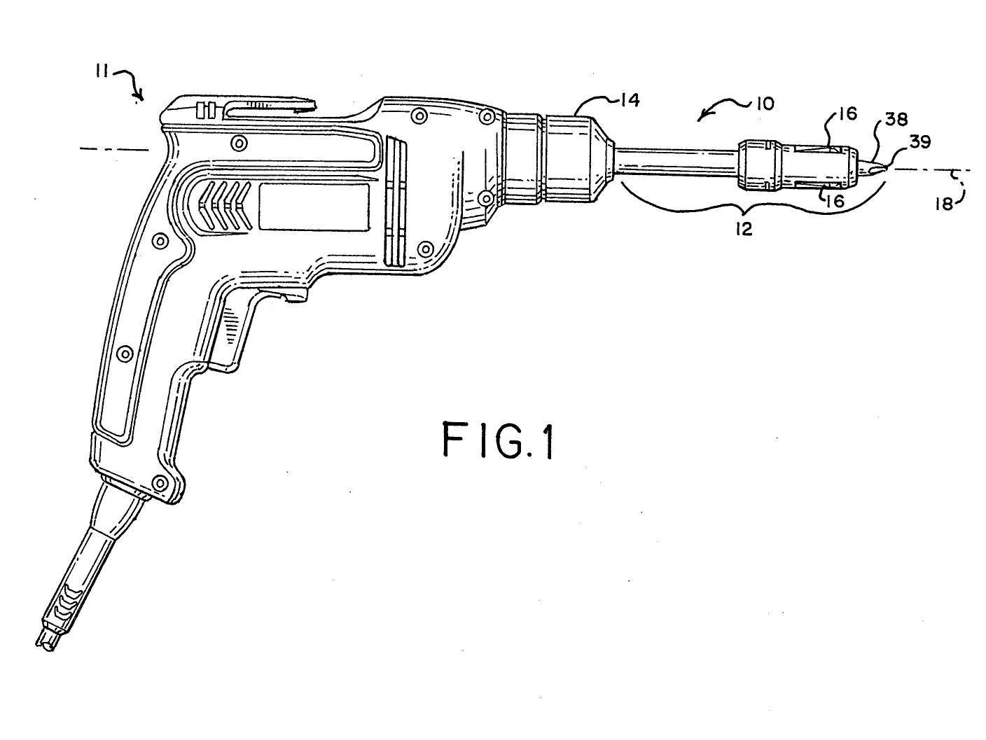

Referring now to the drawings and initially to FIG. 1, a screw guide 10 for a rotary tool, such as an electric drill 11, is shown. The electric drill 11 includes an electric motor configured to rotate a rotating clamp 14 about an axis 18. Other rotary tools for driving fasteners such as screws include pivot drivers, stick drivers, other electric screw drivers and the like. The rotating clamp 14 can be a chuck or a quick coupler of the many sorts known in the art. For example, the quick coupler may be a chuck having a detent ball that is able to selectively move between a locking engagement position, where the detent ball locks a tool bit with respect to the chuck, and a disengagement position, as is disclosed in U.S. Pat. No. 5,398,946 entitled CHUCK HAVING ONE-STEP LOCK AND RELEASE. The screw guide 10 includes a body 12 able to be received within a rotating clamp 14 of the electric drill 11 and a plurality of support members 16 coupled with the body 12 to maintain a screw in a desired orientation. When the screw guide 10 is received within the rotating clamp 14, the screw guide 10 and the rotating clamp 14 rotate in unison with each other.

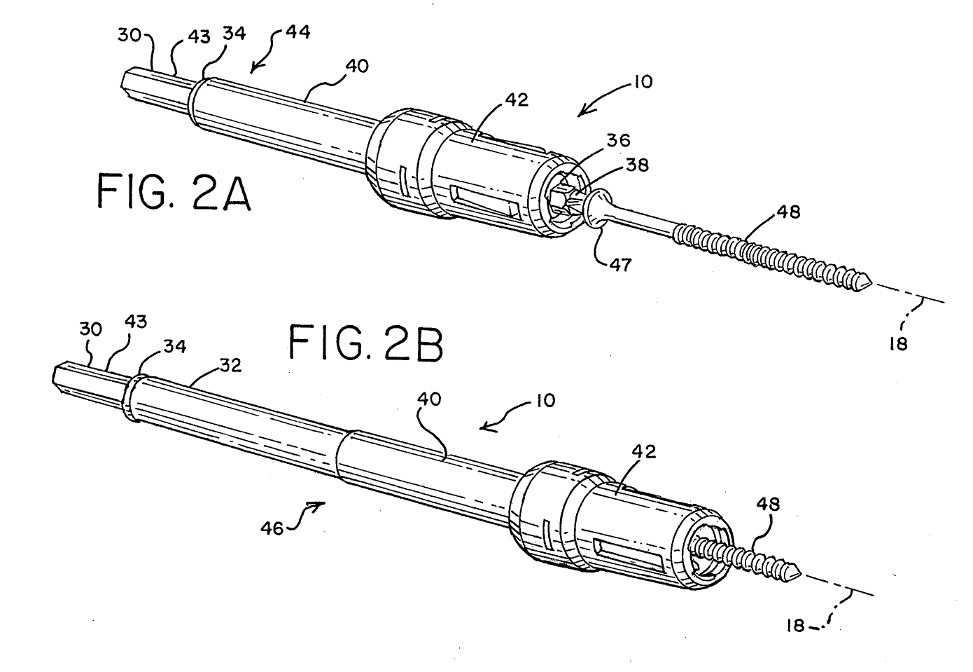

Referring to FIGS. 2a and 2b, the body 12 includes: a shank 30 which is able to be received within the rotating clamp 14 (FIG. 1) of the electric drill 11; an inner portion 32 having a proximal end 34 coupled with the shank 30 and a distal end 36 that is able to receive a screw bit 38; an outer portion 40 telescopically received over the inner portion 32; and a cover 42 positioned over the outer portion 40.

The shank 30 includes a first end 43 having a plurality of keyed surfaces, such as a male hexagon-shaped cross-section, that corresponds to clamping teeth of the rotating clamp 14 so that the rotating clamp 14 is able to form a clamping engagement with the shank 30 and rotate the same. The shank 30 also includes a second end (not shown) having a plurality of keyed surfaces, such as a male square-shaped cross-section, that corresponds to a plurality of keyed surfaces within the inner portion 32 of the body 12, such as a female square-shaped cross-section, so that the shank 30 is able to rotate the inner portion 32 of the body 12.

As indicated above, the inner portion 32 of the body 12 is telescopically received within the outer portion 40 of the body 12 such that the outer portion 40 is able to move longitudinally along the axis 18 with respect to the inner portion 32 between a retracted position 44 (shown in FIG. 2a) and a protracted position 46 (shown in FIG. 2b). When the outer portion 40 of the body 12 is in the retracted position 44, the screw bit 38 is exposed and the support members 16 are in an open position so that a screw 48 can be loaded thereon. When the outer portion 40 of the body 12 is in the protracted position 46, the screw bit 38 is positioned within a cavity of the body 12 and the support members 16 are in a closed position so that they are able to secure the screw 48 in a desired orientation, as is discussed in more detail below.

The cover 42 is fixably secured to the outer portion 40 such that the respective components 40, 42 move longitudinally along the axis 18 in unison. For example, the cover 42 may be secured to the outer portion 40 via a snap-fit engagement, a tab-slot engagement, or other suitable means.

The inner portion 32 is able to rotate with respect to the outer portion 40 such that the outer portion 40, the cover 42, and the support members 16 do not rotate while the rotating clamp 14, the shank 30, and the inner portion 32 are rotating. The inner portion 32 and outer portion 40 include features that prevent the outer portion 40 from sliding off of the inner portion 32. For example, the inner portion 32 may include a snap ring (not shown) that engages a flange on the inner surface of the outer portion 40.

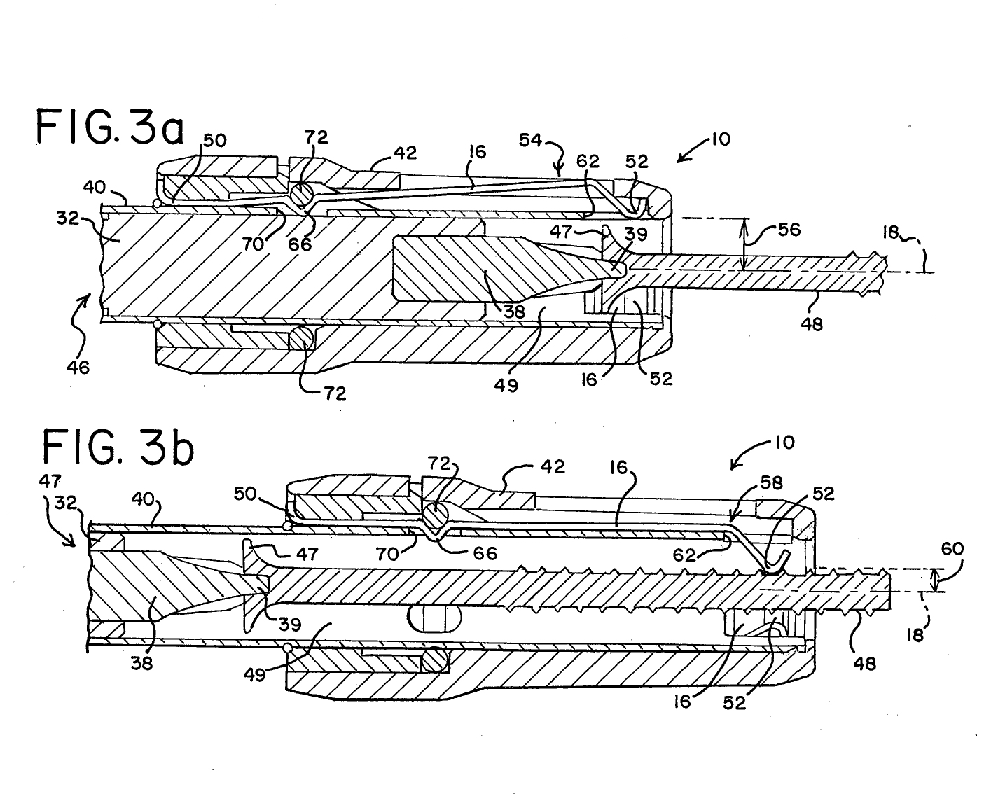

The screw bit 38 includes a distal tip 39 (FIGS. 1, 3a, 3b) configured to fit within an indentation in the screw head 47 (FIGS. 2a, 3a, 3b) such as a standard (a.k.a. “slotted”) screw head having a single, linear indentation; a Phillips screw head having a cross-shaped indentation; a hex-shaped driver head; a hexalobular (a.k.a. “torx”) driver head; a square-shaped, Robertson driver head; one-way driver head; or any other driver head. When the inner portion 32 of the body 12 is rotated in a clockwise direction with respect to the outer portion 40, as the screw 48 is driven, the inner portion 32 moves forward within the screw guide 10. During the forward movement, the support members 16 generally limit the transverse movement of the screw 48 with respect to the axis 18 to prevent the screw 48 from becoming substantially misaligned, as is discussed in more detail below.

Referring to FIGS. 3a and 3b, the support members 16 are coupled with the body 12 and configured to maintain the screw 48 in an orientation substantially parallel with the axis 18 while the screw 48 is positioned within a chamber 49 of the body 12. For example, in the screw guide 10 shown in the figures the support members 16 are each flexible members having a base 50 coupled to the body 12 and a head 52 that is free to move with respect to the axis 18. The support members 16 are generally evenly spaced from each other around a circumference of the outer portion 40 so that they cooperate to urge the screw 48 in the orientation substantially completely parallel with the axis 18. For example, the support members 16 are spring arms substantially equal in size, shape, and spring coefficient so that they each urge the screw 48 with a force of an equal magnitude and cooperate to cause the screw 48 to be in equilibrium when it is substantially completely parallel with the axis 18.

The support arms 16 are movable between an open position 54 (FIG. 3a), where the support arms 16 are each a first distance 56 from the axis 18, and a closed position 58 (FIG. 3b) where the support arms 16 are each a second distance 60 from the axis 18; the second distance 60 is less than the first distance 56. The support members 16 are each biased towards the closed position 58.

During operation of the screw guide 10, the support members 16 are in the open position 54 for loading the screw 48 within the chamber 49 of the body 12 and are in the closed position 58 for supporting the screw 48 and maintaining it in the orientation substantially completely parallel with the axis 18. As used herein, the term “open position” includes any position where the support members 16 are deflected outward against the normal bias and the screw 48 is able to be loaded into the screw guide 10 so that the screw head 47 is able to engage the screw bit 38. Additionally, as used herein, the term “closed position” includes any position where the support members 16 are able to support the screw 48 in an orientation substantially parallel with the axis 18.

The outer portion 40 of the body 12 includes distal openings 62 adjacent to the chamber 49 so that the heads 52 of the support members 16 are able to extend into the chamber 49 and support the screw 48. For example, the heads 52 of the support members 16 include flange portions that extend transversely to the axis 18 into the chamber 49. When the support members 16 are in the closed position 58, the heads 52 extend through the distal openings 62 into the chamber 49 and engage the screw 48.

The support members 16 and the inner portion 32 of the body 12 are configured such that the support members 16 are in the open position 54 when the inner body 32 is in the protracted position 46 (FIG. 3a) and they are in the closed position 58 when the inner body 32 is in the retracted position 44 (FIG. 3b). For example, the support members 16 each define protrusions 66 generally aligned with proximal openings 70 in the outer portion 40 of the body 12 such that the protrusions 66 extend through the proximal openings 70 and into the chamber 49. When the inner portion 32 of the body 12 is in the protracted position 46, the outer surface of the inner portion 32 engages the protrusions 66 and urges the support members 16 into the open position 54 for loading the screw 48 onto the screw bit 38. Conversely, when the inner portion 32 of the body 12 is in the retracted position 44, the outer surface of the inner portion 32 does not engage the protrusions 66, and the protrusions 66 are free to extend into the chamber 49 so that the heads 52 of the support members 16 are able to engage the screw 48 and maintain the orientation thereof.

The protrusions 66 shown in the figures are located between the base 50 and the head 52 of the support members 16. Additionally, an o-ring 72 is positioned around the support members 16 adjacent to the protrusions 66 to further urge the support members 16 towards the closed position 58. The o-ring 72 is preferably a one-piece component made of a flexible material such as rubber or plastic.

When the support arms 16 engage the screw 48, they may each be slightly deflected compared to their natural state, so as to more effectively secure the screw 48. In other words, the support arm heads 52 may define a larger diameter when a screw 48 is positioned within the screw guide 10 than they would absent the screw 48. The spring constant of the support arms 16 may be adjusted as desired to create a desired stiffness. More specifically, the stiffness of the support arms 16 affects the extent to which the support arms 16 are deflected while the screw is driven into the work surface. If the support arms 16 are too stiff the heads 52 may be damaged or prematurely worn by the screw 48, but if the support arms 16 are too loose the screw 48 may be more likely to become skewed.

During one method of operation of the screw guide 10, the screw 48 is loaded onto the screw bit 38 when the inner portion 32 is in the protracted position 46 and the support arms 16 are in the open position 54, as shown in FIG. 3a. The screw bit 38 preferably includes a magnetic component or is itself magnetized so as to improve the engagement between the screw bit 38 and the screw 48. The inner portion 32 is then moved into the retracted position 44 so that the support arms 16 are able to move into engagement with the screw 48. More specifically, as shown in FIG. 3b, the support member heads 52 each engage the screw 48 to secure the screw 48 in a position substantially parallel to the axis 18. In this position, the support arms 16 may be slightly deflected from their natural state so as to have a larger diameter than if the screw 48 was not present. Next, the drill 11, or other type of driver such as a stick driver or a pivot driver, is actuated and the rotating clamp 14 and screw 48 are driven forward towards the work surface. During this action, the support arms 16 preferably continue to engage and support the screw 48 until the inner portion 32 of the body 12 has moved sufficiently forward within the outer portion 40 to engage the protrusions 66 of the support members 16 and urge the support members 16 into the open position 54. With the support members 16 in the open position 54, the screw 48 is released from engagement with the support members 16 so that the screw 48 is easily separated from engagement with the screw bit 38 as desired, such as once the screw 48 is completely driven into the work surface.

The protrusions 66 are preferably positioned along the axis 18 such that the support arms 16 are not moved into the open position 54 until the screw 48 has been driven a desired distance into the work surface. The desired distance is preferably large enough such that forces between the work surface and the screw 48 are able to maintain the orientation of the screw 48 while it is driven further into the work surface.

During another method of operation of the screw guide 10, the screw 48 is loaded into engagement with the screw bit 38 of the inner portion 32 of the body 12 while the support arms 16 are in the closed position 58. For example, the screw 48 may be inserted within the chamber 49 of the body 12 by manually pushing the screw head 48 into engagement with the support member heads 52 and causing the support members 16 to deflect into an open position. In this method, the screw 48 is loaded into engagement with the screw bit 38 of the inner portion 32 while the inner portion 32 is in the retracted position 44.

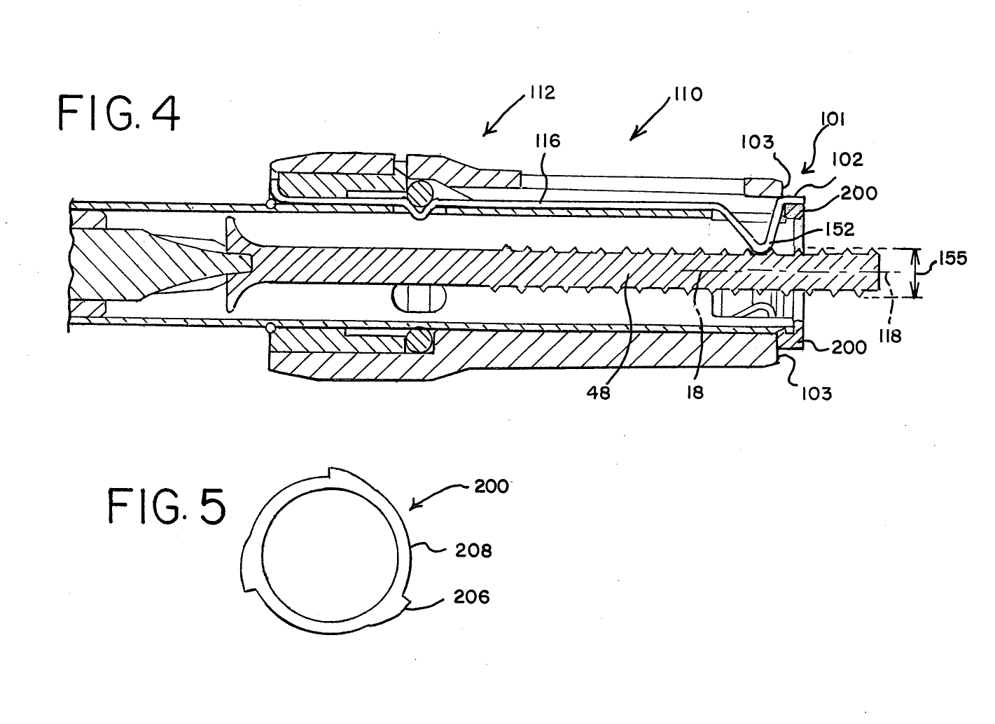

Referring now to FIGS. 4 and 5, another screw guide 110 for a rotary tool having a rotating clamp is shown. The screw guide 110 includes a body 112 and a plurality of support members 116 coupled with the body 112 for maintaining a screw 48 in an orientation substantially parallel with the rotational axis 18 of the rotating clamp.

The screw guide 110 includes an adjustment ring 200 positioned around a distal portion 101 of the screw guide 110. For example, as shown in FIG. 4, the adjustment ring 200 is positioned within a notch 103 at the end of the screw guide 110. The adjustment ring 200 engages tabs 102 extending from the support members 116 so as to control the minimum diameter 155 of the support member heads 152. For example, the adjustment ring 200 is rotatable with respect to the screw guide 110 and includes a varying outer diameter so as to control the position of the support arms 116.

For example, referring to FIG. 5, the adjustment ring 200 includes three raised cam surfaces 206 and three non-raised surfaces 208. When the adjustment ring 200 is aligned such that the tabs 202 each rest on one of the non-raised surfaces 208, then the heads 152 of the support members 116 are able to be positioned relatively closely to the axis 118 and are able to define a relatively small diameter 155. This position is similar to the closed position 58 as shown in FIG. 3b, but when the adjustment ring 200 is rotated such that the tabs 102 each rest on one of the cam surfaces 206, then the support member heads 152 are not able to be positioned as closely to the axis 18 and the diameter 155 becomes relatively larger.

The adjustment ring 200 may be used for loading the screw within the screw guide 110. More specifically, the user is able to adjust the position of the support arms 116 such that the diameter 155 is greater than the screw head diameter, thereby allowing the user to insert the screw into the screw guide chamber. Next, the user can rotate the adjustment ring 200 such as to reduce the diameter 155 and provide support for the screw during drilling. In other words, the drill user is able to align the tabs 102 with the raised cam surfaces 206 during loading and to align the tabs 202 with the non-raised surfaces 208 after the screw has been loaded. The adjustment ring may also be used to maintain a relatively constant support force on the screws regardless of the screw body diameter.

The adjustment ring 200 and/or the screw guide 110 preferably include components to prevent the adjustment ring 200 from slipping off of the distal end 101 of the screw guide 110.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A screw guide for a rotary tool having a rotating clamp rotatable about an axis, the screw guide comprising:
a body configured to be rotatably coupled with the rotating clamp of the rotary tool, the body defining a chamber for receiving a screw; and
a plurality of support members coupled with the body and configured to maintain the screw in an orientation substantially parallel with the axis while the screw is positioned within the chamber.

2. A screw guide as in claim 1, wherein the plurality of support members are flexible members.

3. A screw guide as in claim 2, wherein the flexible members include three flexible members generally evenly spaced from each other around a circumference of the body.

4. A screw guide as in claim 3, wherein the flexible members are spring arms.

5. A screw guide as in claim 1, wherein the plurality of support members are each configured to move between an open position for loading the screw within the chamber, where the support members are each a first distance from the axis, and a closed position for supporting the screw, where the support members are each a second distance from the axis that is less than the first distance.

6. A screw guide as in claim 5, further comprising an adjustment ring coupled with the body and configured to adjust the magnitude of the second distance when the support members are in the closed position.

7. A screw guide as in claim 6, wherein the adjustment ring includes a plurality of cam surfaces each configured to selectively engage one of the support members to adjust the magnitude of the second distance.

8. A screw guide as in claim 5, wherein the body includes an outer portion defining a plurality of proximal openings adjacent to the chamber, and wherein each of the plurality of support members is a spring member including a base portion fixably coupled with the outer portion of the body and a head portion configured to extend into one of the plurality of proximal openings and engage the screw.

9. A screw guide as in claim 8, wherein each of the plurality of spring members is biased towards the closed position.

10. A screw guide as in claim 9, further comprising an o-ring positioned around the plurality of spring members to urge the spring members towards the closed position.

11. A screw guide as in claim 9, wherein the body includes an inner portion telescopically received within the outer portion, and wherein the inner portion is configured to move between a protracted position and a retracted position.

12. A screw guide as in claim 11, wherein the inner portion of the body is configured to engage the plurality of spring members and urge the spring members into the open position when the inner portion is in the protracted position.

13. A screw guide as in claim 12, wherein the outer portion of the body further defines a plurality of distal openings extending into the chamber, and wherein each of the spring members includes a protrusion configured to extend into one of the plurality of distal openings.

14. A screw guide as in claim 13, wherein the inner portion of the body is configured to engage the protrusions of the spring members and urge them into the open position when the inner portion is in the protracted position.

15. A screw guide for a rotary tool having a rotating clamp rotatable about an axis, the screw guide comprising:
a body configured to be rotatably coupled with the rotating clamp of the rotary tool, the body defining a chamber for receiving a screw; and
a plurality of flexible members coupled with the body and configured to maintain the screw in an orientation generally parallel with the axis while the screw is positioned within the chamber, wherein the plurality of flexible members are each configured to move between an open position for loading the screw within the chamber, where the support members are each a first distance from the axis, and a closed position for supporting the screw, where the support members are each a second distance from the axis that is less than the first distance.

16. A screw guide as in claim 15, wherein the body includes an outer portion and an inner portion telescopically received within the outer portion, and wherein the inner portion is configured to move between a protracted position, where the inner portion contacts the flexible members and urges the flexible members into the open position, and a retracted position.

17. A screw guide for a rotary tool having a driving component rotatable about an axis, the screw guide comprising:
a body configured to be rotatably coupled with a driving component of the rotary tool, the body defining a chamber for receiving a screw;
a plurality of flexible members coupled with the body and configured to maintain the screw in an orientation generally parallel with the axis while the screw is positioned within the chamber; and
an adjustment ring coupled with the body and configured to adjust the position of the flexible members.

18. A screw guide for a rotary tool as in claim 17, wherein the adjustment ring includes a plurality of cam surfaces each configured to selectively engage one of the flexible members to adjust the magnitude of the second distance.

19. A screw guide for a rotary tool having a rotating clamp rotatable about an axis, the screw guide comprising:
a body configured to be rotatably coupled with the rotating clamp of the rotary tool, the body defining a chamber for receiving a screw; and
a support member coupled with the body and configured to maintain the screw in an orientation substantially parallel with the axis while the screw is positioned within the chamber.

20. A method of driving a screw into a work surface utilizing a driving tool and a screw guide having support members, the method comprising:
positioning the support members of the screw guide into an open position;
loading the screw into engagement with a driving component of the screw guide; and
positioning the support members of the screw guide such that the support members secure the screw in an orientation generally parallel with an axis of the driving component.

21. A method as in claim 20, wherein the support members are in a closed position during the step of positioning the support members such that the support members secure the screw in the orientation generally parallel with the axis.

22. A method as in claim 21, wherein the support members are slightly deflected with respect to a natural state when they are in the closed position.
